(19) United States
(12) Patent Application Publication
(10) Pub. No.: US 2014/0204067 A1
(43) Pub. Date: Jul. 24, 2014

(54) Pixel Circuits and Driving Schemes for Active Matrix Organic Light Emitting Diodes

(71) Applicant: APPLE INC., Cupertino, CA (US)

(72) Inventor: Vasudha Gupta, Cupertino, CA (US)

(73) Assignee: Apple Inc., Cupertino, CA (US)

(21) Appl. No.: 13/745,932

(22) Filed: Jan. 21, 2013

(51) Int. Cl. G09G 3/32

(52) U.S. Cl. CPC G09G 3/3291
USPC 345/211; 345/76

(57) ABSTRACT

A pixel driving circuit includes a storage capacitor, a first, a second, and a third transistor. A method for driving an organic light emitting diode (OLED) display includes controlling the second transistor by a first signal from a gate line such that the second transistor is switched “Off” for a first phase, and “On” for a second phase and a third phase, “Off” for a fourth phase. During the second phase, storing a threshold voltage of the first transistor on the storage capacitor coupled between the gate and the source of the first transistor. During the third phase, supplying a data voltage from a data line to the gate of the first transistor, and switching off the third transistor by a second signal such that the voltage at an anode of the OLED does not vary with pixel location and provides brightness uniformity for the display.

### TECHNICAL FIELD

Embodiments described herein generally relate to pixel circuits and driving schemes for active matrix organic light emitting diodes (AMOLEDs). More specifically, certain embodiments relate to pixel circuits and driving schemes for high brightness uniformity in large area AMOLED displays and fast refresh rate in high resolution AMOLED displays.

### BACKGROUND

AMOLED (active matrix organic light emitting diode) displays have been developed for use in a variety of computing displays and devices, including notebook computers, desktop computers, tablet computing devices, mobile phones (including smart phones) automobile in-cabin displays, on appliances, as televisions, and so on. An AMOLED display generally includes an array of pixels, each pixel defining an active pixel area and an associated pixel circuit for driving the active pixel area. There are generally two different types of AMOLED displays, namely a bottom emission organic light emitting diode (OLED) and a top emission OLED. In a bottom emission OLED, the OLED area shares co-planar space with associated TFTs and capacitors. That is, the OLED area typically is not stacked or overlapped with the TFT(s) and or capacitor(s). Light is generally emitted from a transparent or semi-transparent bottom electrode and passes through a transparent substrate.

In a top emission OLED, light is emitted through the top surface of the display. Thus, a top emission OLED may place the OLED light-emitting area above or overlapping one or more TFTs and/or capacitors. A planarization layer may separate the OLED light-emitting area from the TFTs and/or capacitors.

In many cases, the bottom emission OLED has a smaller light-emitting aperture than a top emission OLED. In a top emission OLED, light comes out of the cathode layer, which typically requires the cathode layer to be transparent. However, a bottom emission OLED may not need to have a transparent cathode, because light is emitted from the surface opposite the cathode. For large area AMOLED displays, resistive-capacitive (RC) delay on the gate lines and/or data lines may cause non-uniformity or gradients in the luminance of the displays. It is thus desirable to have a pixel circuit that is insensitive to the RC delay and to have a pixel circuit to compensate for the TFT/OLED non-uniformity due to the RC delay.

For many applications, a conventional display refresh rate is typically 60 Hz, i.e. the display may show 60 frames of images per second. Thus, the corresponding refresh period may be about 16.7 milliseconds. In other applications or displays, a 120 Hz refresh rate may be desirable. During the refresh period, an entire frame of an image is refreshed on the display such that all pixel circuits are written with new data voltages. When refreshing the image on the display, each of the rows of pixels is sequentially refreshed. A row time is the time to refresh a single row of pixels, which is roughly equal to the refresh time divided by the number of rows of pixels. For high refresh rates in high resolution displays, it may be desirable to reduce row times. For example, a display having a horizontal resolution on the order of 4,000 pixels, such as a so-called “4K2K” display (e.g., a display having 2160 by 3840 pixels), typically requires a row time less than 4 μs to implement a 120 Hz refresh rate.

A paper titled “0.5-inch XGA Micro-OLED Display on a Silicon Backplane with High-Definition Technologies”, written by Onoyama, in SID 2012 DIGEST, pages 950-953, discusses pixel driving circuits. Such a conventional pixel circuit, along with its driving scheme, provides good compensation for voltage threshold (VT) variation and OLED voltages for a display with a conventional refresh rate of 60 Hz. However, these circuits still have issues with brightness uniformity for large area displays and high refresh rates. Onoyama also requires that its power supply toggles, which is undesirable.

There still remains a need to develop pixel circuits and pixel driving schemes that enable high luminance uniformity in large area displays and high refresh rate in high resolution displays and simplify circuit designs.

### SUMMARY

Embodiments described herein may provide pixel circuits and driving schemes that enable brightness uniformity for large area displays, high refresh rates for high resolution displays, small dynamic ranges on the data line, and may also eliminate power supply (VDD) toggling, thereby simplifying the design of driver chips and flex circuits. The embodiments of the present disclosure may use two, three, four, five or more transistors, and may use additional control signals and additional bias signals. Compared to conventional pixel implementations, the present embodiments may provide better compensation for luminance or brightness non-uniformity in large area displays, higher refresh rates in high resolution displays, and smaller dynamic ranges for the voltage supplied from the data line. The embodiments are applicable to both bottom emission OLEDs and top emission OLEDs.

In one embodiment, a method is provided for driving a pixel circuit for a display. The circuit includes an organic light emitting diode (OLED), a storage capacitor, a first transistor for driving the OLED, a second transistor for switching the OLED, and a third transistor. The method includes controlling the second transistor by a first signal from a gate line such that the second transistor is switched “Off” for a first phase, and “On” for a second phase and a third phase, “Off” for a fourth phase. The method also includes controlling the third transistor by a second signal at the gate of the third transistor. The method further includes, during the second phase, storing a threshold voltage of the first transistor on the storage capacitor coupled between the gate and the source of the first transistor. During the third phase, a data voltage from a data line is supplied to the gate of the first transistor. The method further includes switching off the third transistor by the second signal such that the voltage at an anode of the OLED does not vary with pixel location and provides brightness uniformity for the display.

In another embodiment, a method is provided for driving a pixel circuit for a display. The pixel circuit includes an organic light emitting diode (OLED), a storage capacitor, a first transistor for driving the OLED, and a second transistor and a third transistor as a switch, The method includes toggling to a first value of a power supply signal coupled to the drain of the first transistor to start a first phase. The method also includes, during the first phase, providing a first value of data voltage from a data line to the gate of the first transistor. The method further includes toggling to a second value of the power supply signal to start a second phase. During the second phase, a second value of the data voltage is provided to the gate of the first transistor, where the second value is higher than the first value. The method further includes starting a third phase by a control signal from a gate line, where the control signal is coupled to the second transistor to turn “ON” and “OFF” of the second transistor. During the third phase, a third value of data voltage representing a level of illumination is supplied to the gate of the first transistor for driving the OLED, where the second value is higher than the second value. The method also includes simultaneously providing the first value of a data voltage from a data line during the third phase for a nₜₕ row of pixels of the display and the second value of the data voltage during the second phase for a (n−1)th row of pixels of the display and the third value of the data voltage during the first phase for a (n−2)th row of pixels of the display. The method further includes producing a voltage at the source of the first transistor coupled to an anode of the OLED.

Additional embodiments and features are set forth in part in the description that follows, and in part will become apparent to those skilled in the art upon examination of the specification or may be learned by the practice of the embodiments discussed herein. A further understanding of the nature and advantages of certain embodiments may be realized by reference to the remaining portions of the specification and the drawings, which forms a part of this disclosure.

### BRIEF DESCRIPTION OF THE DRAWINGS

FIG. 1 illustrates a perspective view of a sample electronic device in accordance with embodiments of the present disclosure.

FIG. 2 illustrates an AMOLED pixel array in accordance with embodiments of the present disclosure.

FIG. 3 illustrates an AMOLED pixel circuit in accordance with embodiments of the present disclosure.

FIG. 4A illustrates a pixel circuit in a first embodiment of the present disclosure.

FIG. 4B illustrates a driving scheme for pixel circuit 400A in the first embodiment of the present disclosure.

FIG. 5A illustrates a pixel circuit 500A in a second embodiment of the present disclosure.

FIG. 5B illustrates a driving scheme 500B for the pixel circuit 500A in the second embodiment of the present disclosure.

FIG. 5C illustrates an alternative driving scheme 500C for the pixel circuit 500A in the second embodiment of the present disclosure.

FIG. 6A illustrates a pixel circuit 600A in a third embodiment of the present disclosure.

FIG. 6B illustrates a driving scheme 600B for the pixel circuit 600A in the third embodiment of the present disclosure.

FIG. 7A illustrates a pixel circuit 700A in a fourth embodiment of the present disclosure.

FIG. 7B illustrates a driving scheme 700B for the pixel circuit 700A in the fourth embodiment of the present disclosure.

FIG. 7C illustrates a driving scheme 700C for the pixel circuit 700A in a fifth embodiment of the present disclosure.

FIG. 8A illustrates a pixel circuit 800A in a sixth embodiment of the present disclosure.

FIG. 8B illustrates a driving scheme 800B for the pixel circuit 800A in the sixth embodiment of the present disclosure.

FIG. 9A illustrates a pixel circuit 900A in a seventh embodiment of the present disclosure.

FIG. 9B illustrates a driving scheme 900B for the pixel circuit 900A in the seventh embodiment of the present disclosure.

FIG. 9C illustrates a driving scheme 900C for the pixel circuit 900A in an eighth embodiment of the present disclosure.

FIG. 10A illustrates a pixel circuit 1000A in a ninth embodiment of the present disclosure.

FIG. 10B illustrates a driving scheme 1000B for the pixel circuit 1000A in the ninth embodiment of the present disclosure.

FIG. 11A illustrates a pixel circuit 1100A in a tenth embodiment of the present disclosure.

FIG. 11B illustrates a driving scheme 1100B for the pixel circuit 1100A in the tenth embodiment of the present disclosure.

FIG. 12A illustrates a pixel circuit 1200A in an eleventh embodiment of the present disclosure.

FIG. 12B illustrates a driving scheme 1200B for the pixel circuit 1200A in the eleventh embodiment of the present disclosure.

FIG. 12C illustrates an alternative driving scheme 1200C for the pixel circuit 1200A in the eleventh embodiment of the present disclosure.

FIG. 13A illustrates a pixel circuit 1300A in a twelfth embodiment of the present disclosure.

FIG. 13B illustrates a driving scheme 1300B for the pixel circuit 1300A in the twelfth embodiment of the present disclosure.

FIG. 14A illustrates a pixel circuit 1400A in a thirteenth embodiment of the present disclosure.

FIG. 14B illustrates a driving scheme 1400B for the pixel circuit 1400A in the thirteenth embodiment of the present disclosure.

FIG. 15A illustrates a pixel circuit 1500A in a fourteenth embodiment of the present disclosure.

FIG. 15B illustrates a pixel circuit 1500B in a fifteenth embodiment of the present disclosure.

FIG. 15C illustrates a driving scheme 1500C for the pixel circuits 1500A and 1500B in the fourteenth and fifteenth embodiments of the present disclosure.

FIG. 16A illustrates a pixel circuit 1600A in a sixteenth embodiment of the present disclosure.

FIG. 16B illustrates a driving scheme 1600B for the pixel circuit 1600A in the sixteenth embodiment of the present disclosure.

FIG. 17 illustrates a pixel circuit 1700 in a seventeenth embodiment of the present disclosure.

### DETAILED DESCRIPTION

The present disclosure may be understood by reference to the following detailed description, taken in conjunction with the drawings as described below. It is noted that, for purposes of illustrative clarity, certain elements in various drawings may not be drawn to scale.

Embodiments discussed in the present disclosure provide a pixel circuit that includes or operates with a light emitting device (such as an OLED), a storage device (e.g., capacitor) configured to represent a level of illumination, and a driving device (e.g., transistor) used to drive the OLED. The driving device is permitted to drive the light emitting device to emit light having a luminance level corresponding to the level of illumination represented by the storage device.

The pixel circuits of the present disclosures compensate for brightness non-uniformity in edge pixels and middle pixels due to RC relay in gate lines in large area panels. The pixel circuit may also compensate for variation in threshold voltage and mobility of the driving transistor. The pixel circuits of the present disclosure may have different driving schemes in which the gate, data, VDD or additional control signals are toggled with specific timing control to realize the compensation.

The present disclosure also provides pixel circuits and their associated driving schemes that may reduce row times through substantially parallel operation of different rows during different phases or operation periods for each row. This enables faster refresh rates such as 120 Hz. Specifically, each row time includes three different operation periods or phases, including reset phase as a first phase, VT-generation phase as a second phase, and programming phase as a third phase. Parallel operation of different rows means one phase such as a VT-generation phase for a row and a different phase such as a programming phase for a previous row. This is different from a sequential operation for a conventional pixel circuit as disclosed by Onoyama, i.e. operation of the first phase (reset), second phase (VT-generation), third phase (programming) sequentially for one row, and then operation of the first, second, and third phase of the next row. The sequential operation is required by the conventional pixel circuit of Onoyama and takes longer than the parallel operation presented in this disclosure.

The present disclosure also provides pixel circuits with fewer transistors and capacitors by moving the compensation components to driver integrated circuit (IC) or custom gate driver. These pixel circuits may be suitable for small size displays, such as those used in mobile phones, tablet devices, and other portable computing devices. Such small size displays, for example, those with more than 250 pixels per inch (PPI), have very limited pixel areas. For instance, the pixel area may be less than 80 μm by 80 μm, which allows the pixel circuit to include only a few transistors, such as two or three transistors and control signals, even for a top emission OLED.

The embodiments of the present disclosure also generally avoid toggling power supplies or power lines, such as a source voltage (VDD) and a cathode of the OLED, during regular operation. Toggling the power supplies may induce transients on neighboring signals, consume dynamic power, and thus may require special power circuit designs.

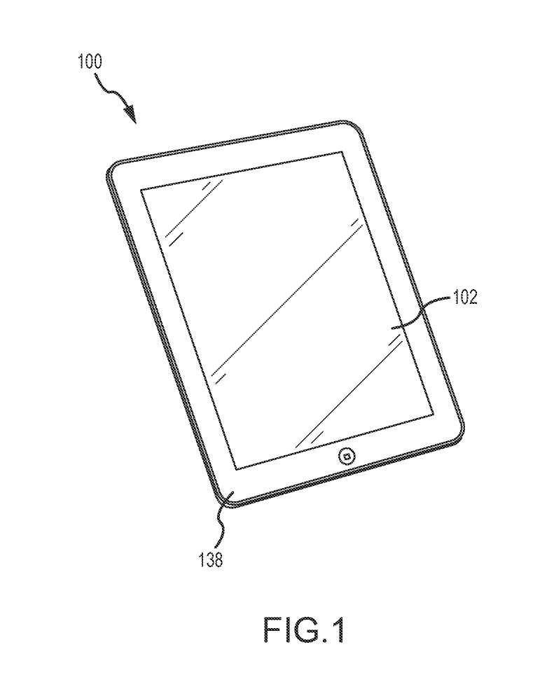

FIG. 1 illustrates a perspective view of a sample electronic device, such as a tablet computer in accordance with embodiments of the present disclosure. The electronic device includes a touch screen display 100 enclosed by a housing 138. The touch screen display 100 may incorporate a cover glass 102 and an AMOLED display behind the cover glass 102, although alternative embodiments may employ an LCD instead of an organic light-emitting display (OLED).

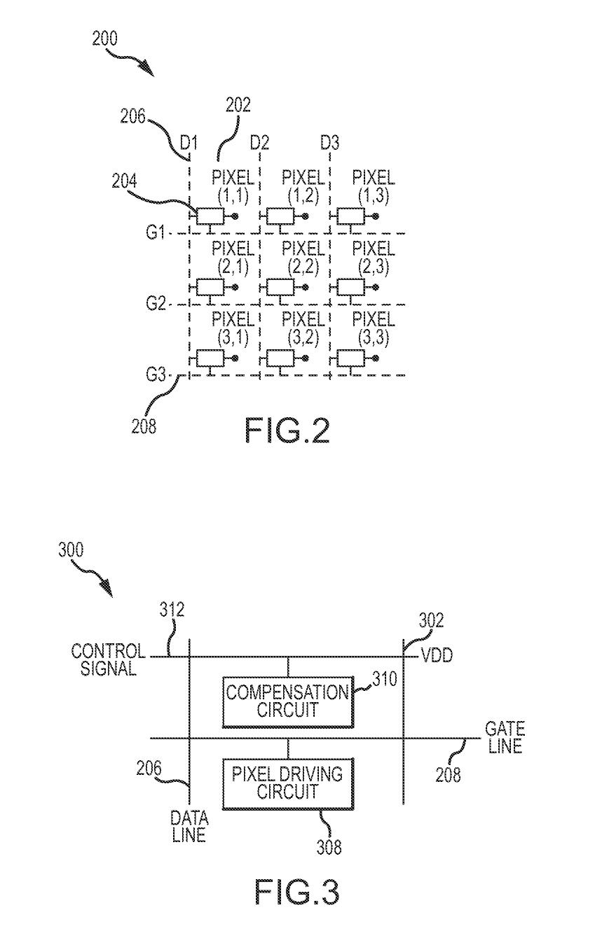

FIG. 2 illustrates an AMOLED pixel array in accordance with embodiments of the present disclosure. An AMOLED display 200 generally includes an array of pixels, each pixel defining an active pixel area 202 and an associated pixel circuit 204 for driving the active pixel area. Each row of active pixel areas 202 typically may be accessed independently using gate lines 208, such as G1, G2 etc. Each column of active pixel areas 202 may also be accessed using data lines 206, such as D1, D2 etc. The active pixel area of the AMOLED display 200 uses an organic light emitting diode (OLED) as a light-emitting element. The OLED is a current driven device, for example, and is driven by an active device or a driving transistor, such as a thin film transistor (TFT). The OLED includes a light-emitting material that emits light when an electric current passes through the material. The AMOLED display does not have a backlight, so that the driving transistors are turned on to drive the OLEDs when the pixels are to be illuminated.

FIG. 3 illustrates an AMOLED pixel circuit in accordance with embodiments of the present disclosure. As shown in FIG. 3, each pixel circuit 300 typically includes a driving circuit 308 and a compensation circuit 310. The driving circuit is coupled to data line 306 and gate line 308 and power supply (VDD) 302. The compensation circuit 310 is coupled to a control line 312 and VDD 302. The driving and compensation circuit work together. The driving circuit 308 includes a driving transistor. The compensation circuit 310 helps provide stability of the driver transistor over time. Typically, the driver is “ON” for the entire frame time of the display and thus is subjected to a degradation of stability over time. Passing electric current through the transistors under the operating voltages of the transistors causes the threshold voltages to increase over the lifetime of the display. When the threshold voltages increase, the currents supplied by the transistors are reduced, thereby reducing the luminance of the OLEDs. Because different pixels have different luminance histories (some are turned on for longer periods of time than others), threshold voltage variations may cause non-uniformity in brightness across the display. The compensation circuit 310 also compensates for spatial mismatch in the transistor properties such as threshold voltage and mobility. This spatial mismatch is produced because of the transistor manufacturing process.

Therefore, the compensation circuit 310 may include a few extra transistors, capacitors, and control signals to compensate for an increase in the “turn ON” voltage of the OLED, and a voltage drop for the OLED and also compensate for voltage variation with pixel location (such as edge pixel or center pixel) due to RC delay.

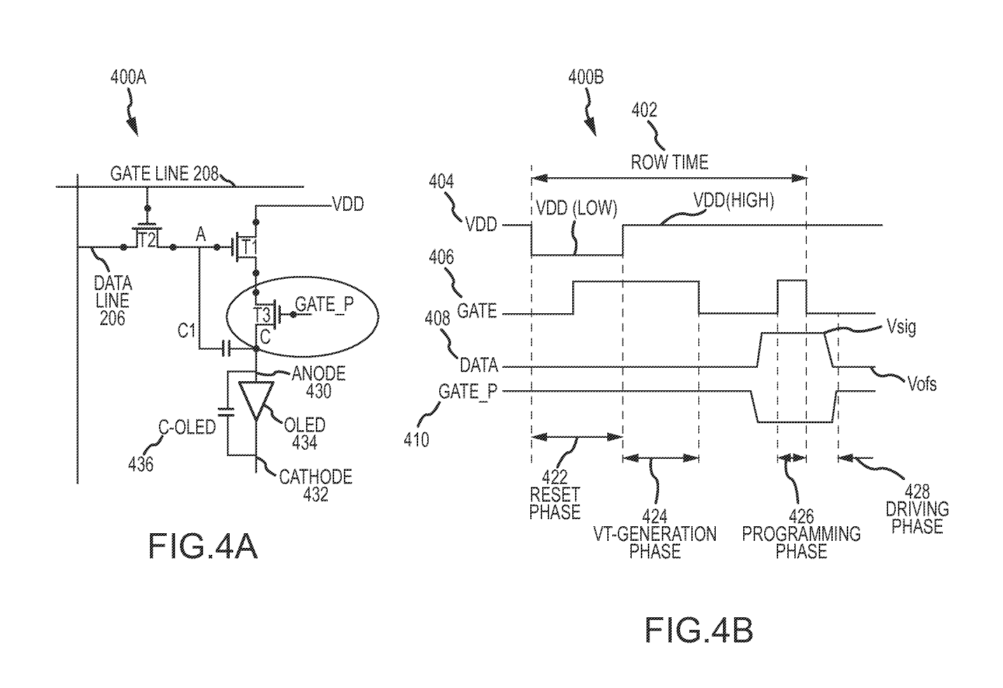

FIG. 4A illustrates a pixel circuit in a first embodiment of the present disclosure. Pixel circuit 400A may include an extra transistor T₃, and a control signal GATE_P when compared to a conventional pixel circuit. A conventional pixel circuit generally includes two thin film transistors (TFTs), i.e. transistors T₁ and T₂, and a storage capacitor C. The transistor T₁ is used as a driver for the OLED 434 and is connected in series with the OLED to regulate the current through the OLED. The driver transistor T₁ supplies a current to the OLED according to the voltage level stored in the storage capacitor C1 so that the OLED operates at a desired luminance level. The transistor T₂ is used as a switch to apply a desired voltage to the gate of T₁. The storage capacitor C₁ stores a voltage level representing a desired luminance of a pixel. Capacitor C_{oled} 436 is associated with the OLED layers in the OLED. The luminance of the OLED depends on the OLED current, which is provided by the driver or transistor T₁. The current through the OLED only goes one way from anode to cathode of the OLED.

Transistor T₃ is between the source of driver transistor T₁ and anode 430 of OLED 434 at node C. Storage capacitor C₁ is between the gate of transistor T₁ at node A and node C. Pixel circuit 400A includes a storage capacitor C₁ that stores a voltage for controlling transistor T₁, and a switch transistor T₂ that connects the capacitor C₁ to the data line 206. The data line 206 supplies a data voltage V_{data} representing a user-defined pixel luminance level. Pixel circuit 400A operates with particular signal timings that are configured for compensating changes for large area brightness non-uniformity so that the OLED emits light at a luminance level substantially independent of the pixel locations in the large area display; this luminance level may be user-defined, system-defined or a default.

Transistors T₁, T₂, T₃, and storage capacitor C₁ form a data sampled current source that supplies the current to OLED at a current level that is governed by the data voltage V_{data}, provided by data line 206 from a display integrated circuit (IC) driver (not shown). Storage capacitor C₁ is arranged between a gate of transistor T₁ at node A and a source of transistor T₃ at node C. Transistor T₁ provides current to the OLED. T₁ generally operates in its saturation region to ensure that the current is a function of the gate voltage. For the saturation region, V_{ds} is equal or greater than V_{gs}−Vₜₕ, where V_{gs} represents the gate-to-source voltage of transistor T₁, and V_{ds} represents the drain-to-source voltage of transistor T₁.

A the end of the programming phase, voltage V_{gs} is substantially equal to (V_{data}+Vₜₕ) and is established across storage capacitor C₁, i.e. the gate-to-source voltage V_{gs} is the sum of the V_{data} and Vₜₕ of transistor T₁, which enables brightness uniformity for large area displays. The reason for this uniformity is that the brightness of the OLED depends upon the current supplied by transistor T₁ when operating in the saturation region, which is proportional to (V_{gs}−Vₜₕ)²=V_{data}², and that the brightness is independent of Vₜₕ, and is only dependent upon V_{data}.

Compensation for the variations of the threshold voltage and the brightness non-uniformity resulting from RC delay may be performed by switching the control voltage that is applied to pixel circuit 400A at different time intervals. In a first time interval of a reset phase, the data voltage can be set to a low voltage, and VDD can be set to a voltage lower than data in order to completely turn off the OLED. The voltage at node C settles to below the turn on voltage of the OLED. Also, all pixels achieve the same voltage at node C during the reset phase. In a second time interval of a VT-generation phase, the transistor T₁ charges the storage capacitor C₁ so that the voltage on the storage capacitor C₁ becomes substantially the same as the threshold voltage Vₜₕ of transistor T₁. This will compensate for the threshold variation. In a third time interval of a programming phase, a data voltage V_{data} changes from Vₒₗₛ to V_{sig} and is supplied to the capacitor C₁ to cause the capacitor C1 to store a voltage level substantially the same as a sum of data voltage V_{data} and threshold voltage Vₜₕ. During a fourth interval of a driving phase, the driver transistor T₁ supplies the OLED with a driving current proportional to the data voltage V_{data}.

The OLED illuminates when a voltage measured from an anode 430 to a cathode 432 is above an onset voltage. The OLED's brightness varies with the data voltage or gate voltage of T₁ or voltage at node C. Cathode 432 may be connected to all pixels in the display to provide a common current return. Each OLED has the anode 430 connected to the source of T₁.

FIG. 4B illustrates a driving scheme for pixel circuit 400A in a first embodiment of the present disclosure. The driving scheme 400B includes waveforms for control signals from voltage VDD, gate line 208, data line 206, and voltage Gate_P. Generally, there are four phases in driving the OLED. The four phases include a reset phase 422, a voltage threshold generation (VT-generation) phase 424, a programming phase 426, and a driving phase 428. A row time includes the time periods for the reset phase, the VT-generation phase, and the programming phase.

As shown, reset phase 422 starts by setting VDD equal to VDD_{low} (e.g., to a low voltage) and ends by setting VDD to VDD_{HIGH} (e.g., to a high voltage). VT-generation phase 424 starts by setting VDD 404 high as VDD_{HIGH} and ends by setting GATE to “low”. Programming phase 426 starts by setting voltage GATE 406 from gate line 208 high again and ends by setting GATE low and then driving phase 428 starts. voltage DATA 408 from data line 206 is set high during programming phase 426 and initial driving phase 428. As shown in FIG. 4B, the GATE_P 410 is set high during the reset phase and VT-generation phase, but is set low during the programming phase. As a result, the pixel circuit 400A switches “OFF” the transistor T₃ during the programming phase, such that the voltage V_{c} at node C does not vary with pixel location such as edge pixels or middle pixels. This pixel circuit 400A along with the driving scheme 400B eliminates differential charging of node C due to the RC delay and thus improves uniformity in large area displays.

Transistor T₂ operation varies during different time intervals or different phases. In the first time interval of the reset phase, transistor T₂ is turned “OFF”. During the latter half of the reset phase, when the GATE 406 goes high, T₂ is turned “ON” to ensure that Node C is at the same voltage as VDDlow. In the second time interval of the VT-generation phase and the third time interval of the programming phase, transistor T₂ is turned “ON” to connect terminal A of capacitor C₁ to a reference voltage provided on the data line. Transistor T₁ operates as a data voltage-sampling transistor that connects terminal A to a data voltage V_{data} provided on data line 206 so that the data voltage can be written into the capacitor C₁. In the fourth time interval of the driving phase, transistor T₂ is turned “OFF”.

A percentage uniformity versus data voltage or grey level of luminance for a 55-inch 4K2K (2160 by 3840) display may be enhanced by using the pixel circuit 400A and associated driving scheme “400B, and a conventional pixel circuit. The “percentage uniformity” is defined by the brightness difference between a middle pixel and an edge pixel of a display. The uniformity of the pixel circuit 400A, along with the driving scheme 400B, generally provides better percentage uniformity than the conventional pixel circuit with its driving scheme for all brightness levels.

Pixel circuit 400A is not sensitive to the threshold voltage variation. The current through the OLED is determined by the amount of a gate-to-source voltage that is above a threshold voltage Vₜₕ of transistor T₁. The threshold voltage of transistor T₁ may change over time.

Pixel circuit 400A is also not sensitive to RC delay, or may be less sensitive to RC delay than a conventional pixel circuit. In contrast, conventional pixel circuits tend to be very sensitive to the RC delay on the gate line 208, especially for large area AMOLED displays. The sensitivity to the RC delay results in brightness non-uniformity for large area displays. The large area display includes pixels in the middle of the display, referred to “middle pixels,” and edge pixels that are outside the middle pixels. During the programming phase, the source of the driver T₁ at node C starts charging the storage capacitor C₁. The extent of charging to the storage capacitor C₁ depends on the slope of the gate rise time of transistor T₁. For the middle pixels of the large area display, the gate line 208 has a larger resistive-capacitive (RC) delay that the edge pixels, such that node C charges much slower for the middle pixels than for the edge pixels of the large area display. Node A always charges to an applied programming voltage denoted by V_{sig}. This means that the TFT gate-to-source voltage V_{gs} is much larger in the middle pixels than in the edge pixels,

The RC delay affects a rise time for a voltage signal to reach its maximum level at node C. For a conventional pixel circuit, the rise time increases from the gate line 208 to node A and further increases from node A to node C, such that there is a differential charging between the edge and center pixels at node C due to the RC delay, while there is no differential charging at node A between edge pixels and center pixels. The voltage at node C of the center pixels is lower than the voltage of for the edge pixels and gate-to-source voltage V_{gs} is equal to V_{A}−V_{C}, which is normally larger for the center pixels than for the edge pixels, and thus the center pixels are brighter for the display driven by the conventional pixel circuit. Generally, certain conventional pixel circuits have a brightness percentage uniformity between edge pixels and middle pixels that varies from about 16% to about 18% due to RC delay in the gate line. The middle pixels are brighter than the edge pixels. This difference or non-uniformity increases with the data voltage that controls the brightness level of the display.

Pixel circuit 400A does the reset, threshold voltage-generation and programming phases for each row of pixels and the following row of pixels sequentially. The data line is first set to a low value V_{ofs} during the reset phase and VT-generation phase, then set to a high value V_{sig} during a programming phase. V_{sig} represents a programming voltage. The VT-generation phase of one row should not overlap with the programming phase of another row, because the same data line can not be used to supply the data voltage of both low value V_{ofs} and high value V_{sig}. Therefore, pixel circuit 400A still has a relative long row time, and is suitable for conventional refresh rate, such as 60 Hz.

In the first embodiment, during the programming phase, the voltage at node C does not increase as node A is programmed. This increases the gate-to-source voltage V_{gs} of driver transistor T₁, and reduces the required dynamic range on the data line 206 and thus requires smaller dynamic range than a conventional pixel circuit.

The first embodiment uses three transistors, provides large area uniformity and small dynamic range on the data line. However, the first embodiment may employ an additional control line, toggle VDD between two values VDDhigh and VDDlow, and may have a relatively complex gate driver design because a separate VDD line is used per row as a result of the VDD toggling.

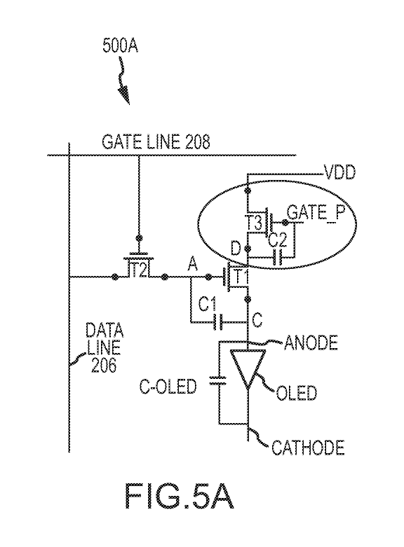

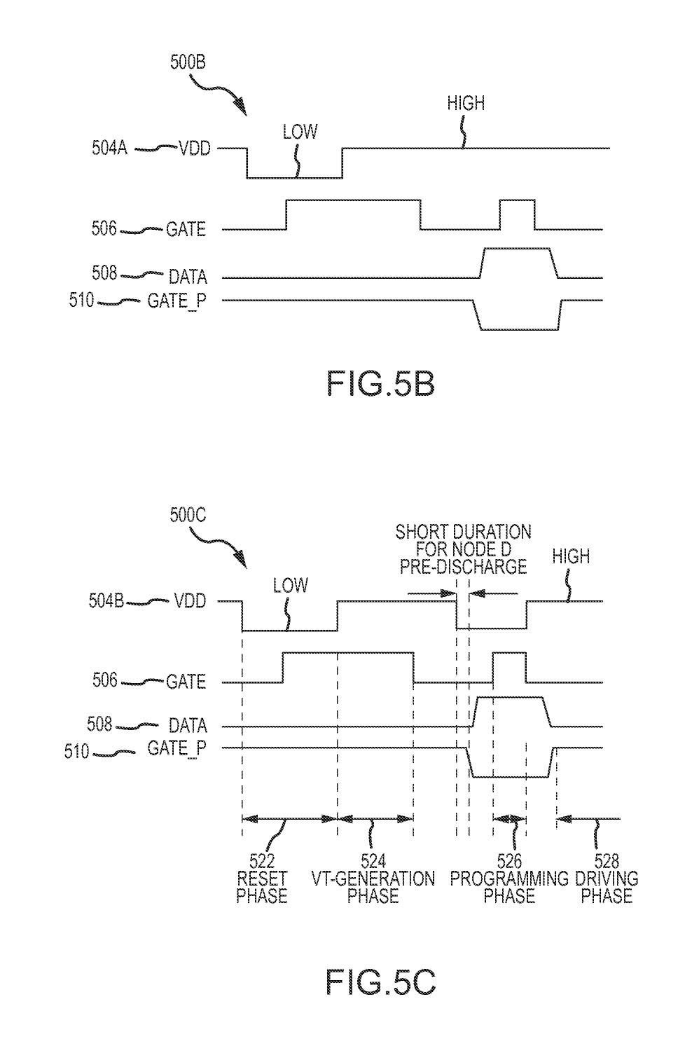

FIG. 5A illustrates a pixel circuit 500A in a second embodiment of the present disclosure. Pixel circuit 500A includes a transistor T₃ between VDD and drain of driver transistor T₁ at node D. Similar to pixel circuit 400A, transistor T₃ is switched “OFF” during programming phase 526 as controlled by voltage GATE_P 510, such that the voltage V_{c} at node C does not increase. This eliminates differential charging of node C due to RC delay. The voltage V_{c} developed at node C during the VT-generation phase 524 is Vₐ−Vₜₕ, where Vₐ is the voltage at node A and V_{c} is the voltage at node C. Therefore, capacitor C₁ between node A and node C stores the threshold voltage for the driver transistor T₁. Pixel circuit 500A also includes an extra capacitor C₂ between the drain of driver transistor T₁ at node D and the gate of transistor T₃ controlled by voltage GATE_P 510. During the programming phase 526, there may be charge sharing between nodes C and D, which can increase non-uniformity and reduce compensation quality. The capacitor C₂ may be small such that node D is pre-discharged at the beginning of programming phase 526. Note that pre-discharging of node D has little impact on the voltage at node C, which stores threshold voltage because of the large C_{oled}. For some type of TFTs, small capacitor C₂ may be a part of the TFT structure and may not be needed separately.

FIG. 5B illustrates a driving scheme 500B for the pixel circuit 500A in the second embodiment of the present disclosure. This driving scheme 500B is similar to driving scheme 400B. For example, GATE 506, DATA 508, and GATE_P 510 are similar to GATE 406, DATA 408, and GATE_P 410.

FIG. 5C illustrates an alternative driving scheme 500C for the pixel circuit 500A in the second embodiment of the present disclosure. VDD 504B for driving scheme 500C is different from that in driving scheme 500B. In contrast to the VDD 504A as shown in driving scheme 500B, the VDD 504B may be toggled shortly before GATE_P 510 changes to ensure that node D is pre-discharged, without impacting node C. Furthermore, pixel circuit 400A stores voltage V_{c} at node C that includes threshold voltage of driver transistor T₁ and drain-to-source voltage V_{ds} of T₃, while pixel circuit 500A stores only the threshold voltage of T₁ at node C. Therefore, pixel circuit 500A provides better TFT compensation and better uniformity that pixel circuit 400A.

Simulation results of percentage uniformity for a 55-inches 4K2K display have been obtained by using the pixel circuit 500A and driving scheme 500B or 500C. The pixel circuit 500A shows better uniformity than pixel circuit 400A, which is better than the conventional pixel circuit with its driving scheme.

The pixel circuit 500A may have smaller compensation error than pixel circuit 400A with driving scheme 400B. The second embodiment, as shown, generally uses three transistors, provides better large area uniformity and small dynamic range on the data line than the first embodiment, and requires no additional bias lines. However, the second embodiment requires an additional control line, toggles VDD, and may have a relatively complex gate driver design due to VDD toggling.

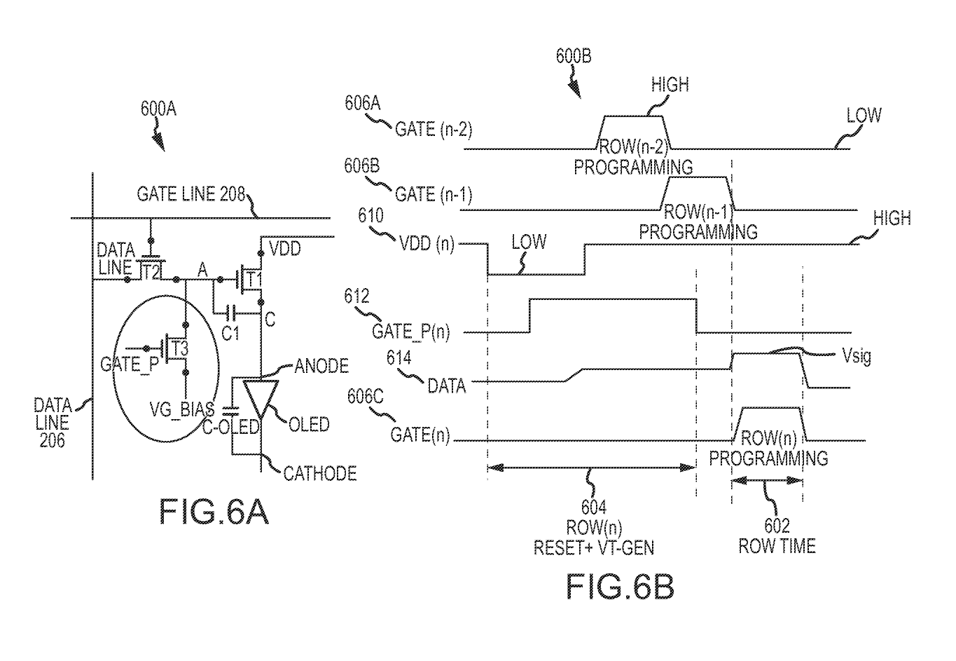

FIG. 6A illustrates a pixel circuit 600A in a third embodiment of the present disclosure. Pixel circuit 600A includes an extra transistor T₃ connected to node A. The transistor T₃ is arranged differently from the pixel circuits 400A and 500A. This third embodiment provides smaller row time than the conventional pixel circuit, and the first and second embodiments of the present disclosure. The transistor T₃ has an additional control signal GATE_P(n) 612, and an additional bias line V_{G}_{_{—}}_{BIAS} compared to the conventional pixel circuit. This pixel circuit 600A allows to turn on transistor T₂ such that data line 206 supplies data voltage to node A during programming phase for row (n−1), and simultaneously turn off transistor T₂ of the pixel in row (n), such that data line 206 does not supply data voltage to node A of the pixel in row (n). Therefore, parallel operation of reset or VT-generation for one row and programming for another row is enabled.

FIG. 6B illustrates a driving scheme 600B for the pixel circuit 600A in the third embodiment of the present disclosure. As shown, transistor T₃ is used to apply bias voltage V_{G}_{_{—}}_{BIAS} to node A during the Reset phase and VT-generation phase 604 for Row(n). During this time, data line 206 may be used to program previous rows, such as Row(n−2), Row(n−1), controlled by GATE(n−2) 606A and GATE (n−1) 606B, respectively. The new row time is as indicated by 602 for programming row (n), controlled by GATE(n) 606C, which is much shorter than the conventional row time, for example, compared to row time 402 for pixel circuit 400A. The pixel circuit 600A enables faster refresh rates than the conventional refresh rate such as 60 Hz. VDD 610 toggles between “LOW” and “HIGH” values. The extra bias line V_{G}_{_{—}}_{Bias} may be shorted to cathode of OLED, or may be separate. DATA 614 may have several values, which are used for programming different rows. DATA 614 is only used to apply voltage during the programming phase. The voltage at Node A during reset and VT generation phase is applied through T₃ by the VG_BIAS.

The third embodiment employs three transistors and provides high refresh rates compared to a conventional pixel circuit and the first and second embodiments of the present disclosure, but requires an additional control line, an additional bias line, toggles VDD, and may have a relatively complex gate driver design. The additional VG_BIAS can be connected to the cathode. The third embodiment may be suitable for small size, high resolution, high refresh rate panels.

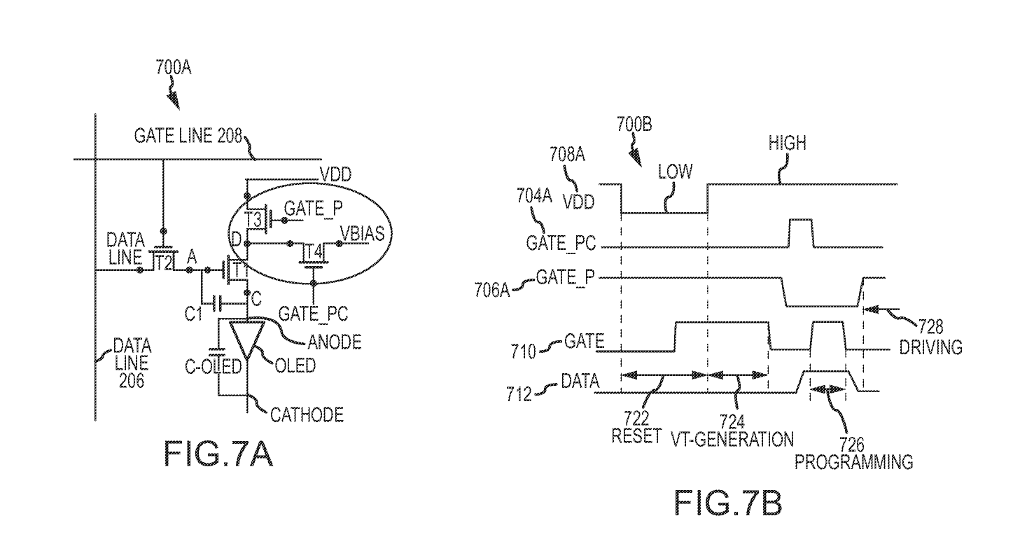

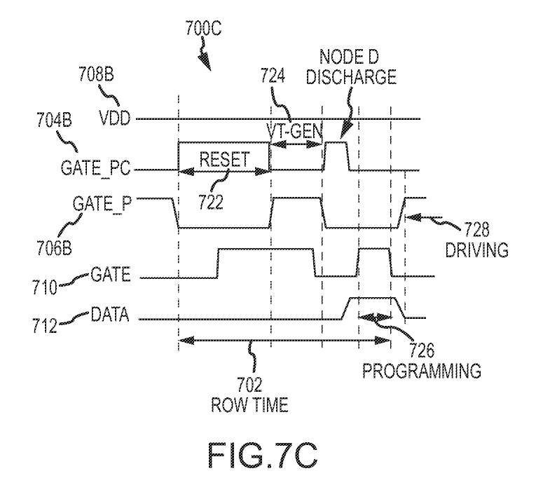

FIG. 7A illustrates a pixel circuit 700A in a fourth embodiment of the present disclosure. Pixel circuit 700A includes two extra transistors T₃ and T₄ compared to the conventional pixel circuit, with two additional control signals GATE_P and GATE_PC for transistors T₃ and T₄, respectfully. The fourth embodiment is modified from the second embodiment. In the fourth embodiment, transistor T₃ is switched “OFF” to prevent differential charging at node C or anode of the OLED during the programming phase, such that the voltage at node C does not vary with pixel location, such as edge pixel or middle pixels of the display. Transistor T₄ is used to mildly pre-discharge node D to similar level as node C, to prevent charge sharing and loss of compensation during the programming phase. This embodiment provides better compensation than the second embodiment.

FIG. 7B illustrates a driving scheme 700B for the pixel circuit 700A in the fourth embodiment of the present disclosure. As shown in FIG. 7B, VDD 708A is toggled in the reset phase 722 such that VDD 708A is be applied per row. Row time 702 includes the reset phase 722, the VT-generation phase 724, and the programming phase 726, but does not include the driving phase 728. GATE 710 and DATA 712 are similar to GATE 406 and DATA 408 for pixel circuit 400A, shown in FIG. 4B. The fourth embodiment uses four transistors, provides better large area uniformity and small dynamic range on the data line than the conventional pixel circuit), and requires one additional bias line, which can be eliminated by connecting to the cathode or cathode line. However, the fourth embodiment may use two additional control lines, toggles VDD, and may have a relatively complex gate driver design.

FIG. 7C illustrates a driving scheme 700C for the pixel circuit 700A in a fifth embodiment of the present disclosure. As shown in FIG. 7C, VDD does not toggle such that VDD does not need to be supplied per row, and VDD may be laid out in the form of a grid to help reduce the current (IR) drop in the OLED. This VDD 708B is enabled, because GATE_PC waveform 704B and GATE_P 706B for driving scheme 700C are different from GATE_PC waveform 704A and GATE_P 706A for driving scheme 700B.

The fifth embodiment typically has four transistors, provides very good large area uniformity and small dynamic range on the data line, and has a fixed VDD, but employs an additional bias line and two additional control lines. The fifth embodiment also has a simple gate driver design compared to the fourth embodiment due to a fixed VDD. The additional VG_BIAS can be connected to the cathode line.

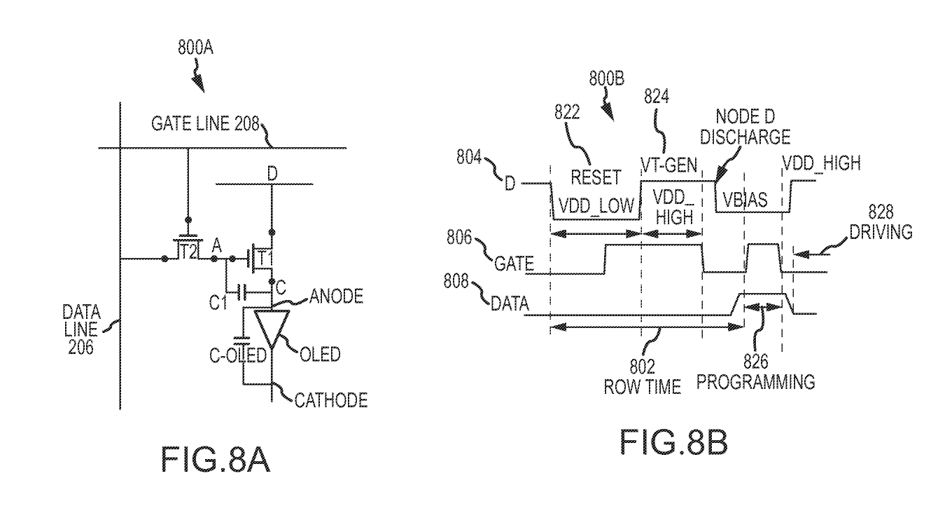

FIG. 8A illustrates a pixel circuit 800A in a sixth embodiment of the present disclosure. Pixel circuit 800A is a simplified version of pixel circuit 700A. Pixel circuit 800A does not include transistors T₃ and T₄ as shown in FIG. 7A. Instead, transistors T₃ and T₄ may be moved to the gate driver (not shown), which helps provide a more compact two transistors and two capacitors (2T2C) pixel circuit. This sixth embodiment also eliminates control signals GATE_PC and GATE_P as shown in FIG. 7A. Signal D is toggled between “HIGH” and “LOW” values.

FIG. 8B illustrates a driving scheme 800B for the pixel circuit 800A in the sixth embodiment of the present disclosure. As shown, VDD 804 at node D is toggled low when reset phase 822 starts, and VDD 804 is toggled high when VT-generation phase 824 starts, which is provided per row. Node D as shown in FIG. 8B is routed horizontally per row. The programming phase 826 starts when GATE 806 is set “HIGH” and V_{BIAS} is applied for node D discharge. In this embodiment, the number of control signals per pixel is also reduced compared to pixel circuit 700A, which reduces the overlap parasitic capacitance, and makes the design more feasible for large area displays. For pixel circuit 800A, VDD may not be fixed, as the waveform VDD 804 is required to enable this design. Again, DATA 808 is similar to DATA 408 for pixel circuit 400A.

The sixth embodiment uses only two transistors, which is less than the fourth and fifth embodiments. The sixth embodiments still provides better large area uniformity and small dynamic range than a conventional pixel circuit, and requires no additional bias line and no additional control line, but toggles VDD. The sixth embodiment may have a complex gate driver design due to VDD toggling.

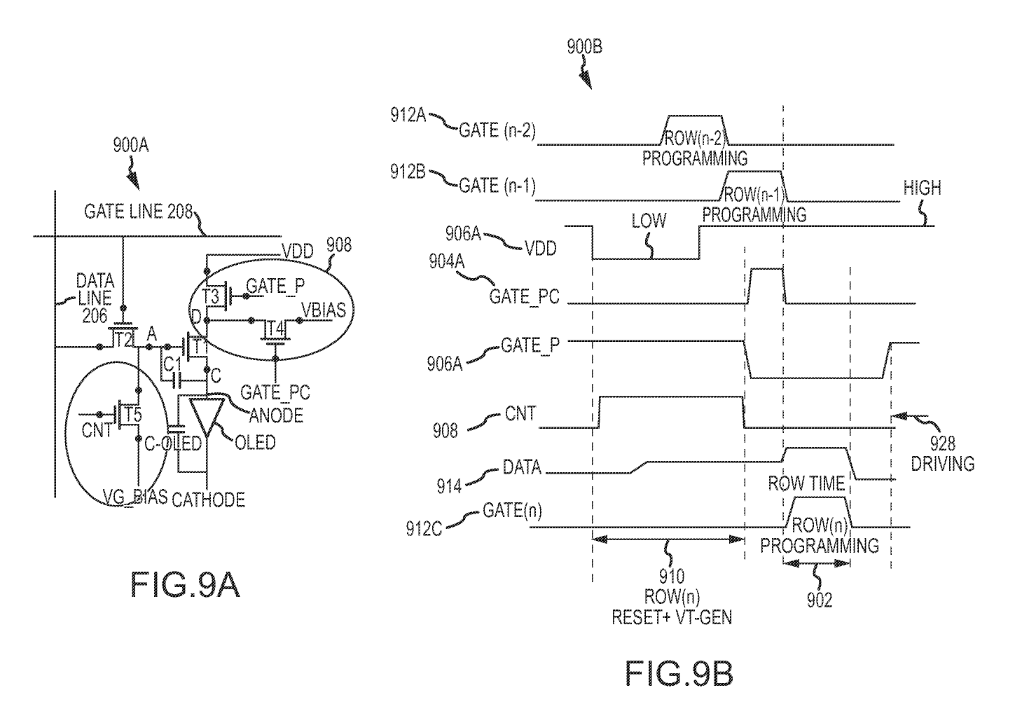

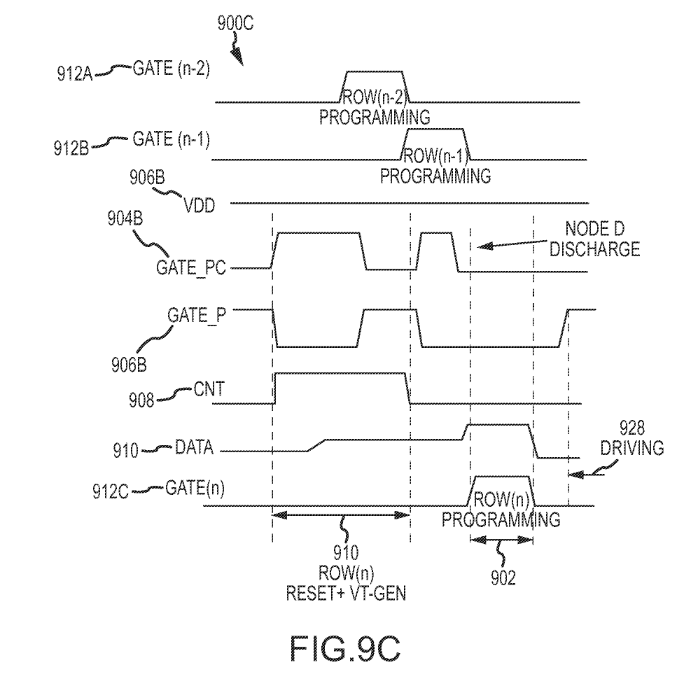

FIG. 9A illustrates a pixel circuit 900A in a seventh embodiment of the present disclosure. Pixel circuit 900A includes five transistors and two capacitors (5T2C). This embodiment combines features of pixel circuits 600A and 700A, as shown in FIGS. 6A and 7A. As seen in FIG. 900A, T₅ is similar to T₃ of pixel circuit 600A in FIG. 6A, CNT 908 is similar to GATE_P 612 of pixel circuit 600A. This feature provides small row time for pixel circuit 900A. Transistor T₃ and T₄ and their control signals GATE_P and VBIAS in circle 908 is the same as that in circuit in circle 708 in FIG. 7A. FIG. 9B illustrates a driving scheme 900B for the pixel circuit 900A in the seventh embodiment of the present disclosure. In driving scheme 900B, the VDD 906A is not fixed. Row time 902 is similar to row time 602 for pixel circuit 600A, as the driving scheme shown in FIG. 600B. Row (n−2) and row (n−1) can be programmed by GATE(n−2) 912A and GATE(n−1) 912B, respectively, while row (n) is in the reset and VT-generation phase 910. Within the combined reset and VT-generation phase, VDD remains low during the entire reset phase, and the remaining is the VT-generation phase. Driving phase 928 starts when GATE_P 906B is set to a “HIGH” value, following the programming phase. Note that DATA 914 is similar to DATA 614 for driving scheme 600B for pixel circuit 600A.

FIG. 9C illustrates an alternative driving scheme 900C for the pixel circuit 900A in an eighth embodiment of the present disclosure. In driving scheme 900C, the VDD 906B is fixed. Pixel circuit 900A includes three additional voltage control signals GATE_P and GATE_PC as well as CNT. Note that GATE_PC and GATE_P waveforms 904A and 906A for driving scheme 900B are different from waveforms 904B and 906B for driving scheme 900C.

This pixel circuit and its associated driving schemes may be used for large area AMOELD displays, or for top emission small size AMOLED displays. With design optimization, it is possible to short V_{G}_{_{—}}_{BIAS}, V_{BIAS} and cathode 902 in pixel circuit 900A.

The seventh embodiment uses five transistors, provides better large area uniformity, high refresh rate, and small dynamic range than conventional pixel circuit, and requires no additional bias line. However, the seventh embodiment requires three additional control lines, and toggles VDD. The seventh embodiment may have a complex gate driver design. The eighth embodiment is similar to the seventh embodiment except having a fixed VDD with an additional bias line and simple gate driver design due to fixed VDD.

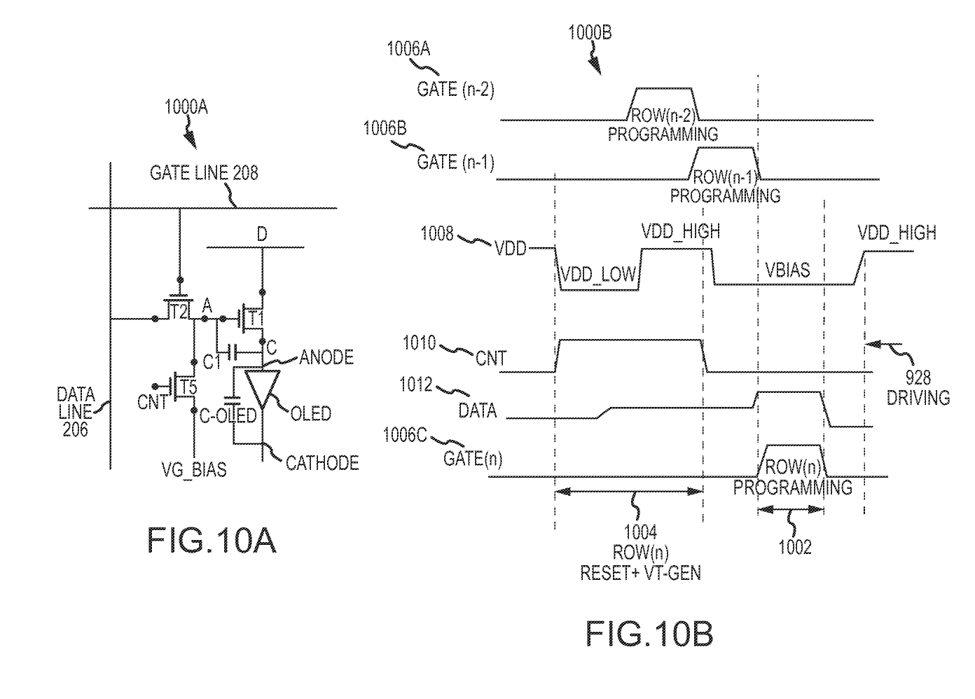

FIG. 10A illustrates a pixel circuit 1000A in a ninth embodiment of the present disclosure. This embodiment is a simplified version of pixel circuit 900A. Pixel circuit 1000A eliminates T₃ and T₄ from pixel circuit 900A. In this embodiment, transistors T₃ and T₄ may be moved to the driver IC (not shown) to derive a more compact three transistors and two capacitors (3T2C) pixel circuit 1000A, with faster refresh rate and better large area uniformity than the conventional pixel circuit. This embodiment requires an additional control signal CNT 1010 similar to CNT 908. FIG. 10B illustrates a driving scheme 1000B for the pixel circuit 1000A in the ninth embodiment of the present disclosure. Node D waveform 1008 for VDD toggles between “LOW” and “HIGH” values. The ninth embodiment also provides small dynamic range on the data line, and requires no additional bias line. However, the ninth embodiment toggles VDD and may have a complex gate driver design. Note that DATA 1012 is similar to DATA 614 for driving scheme 600B for pixel circuit 600A. GATE(n) 1006C, GATE(n−1) 1006B and GATE(n−2) 1006A are similar to those for driving scheme 600B. Because of the parallel operation of different phases 1004 and 1002 for different rows, the row programming time 1002 becomes the row time for this pixel circuit 1000A. Row time 1002 is shorter than row time 402 for pixel circuit 400A.

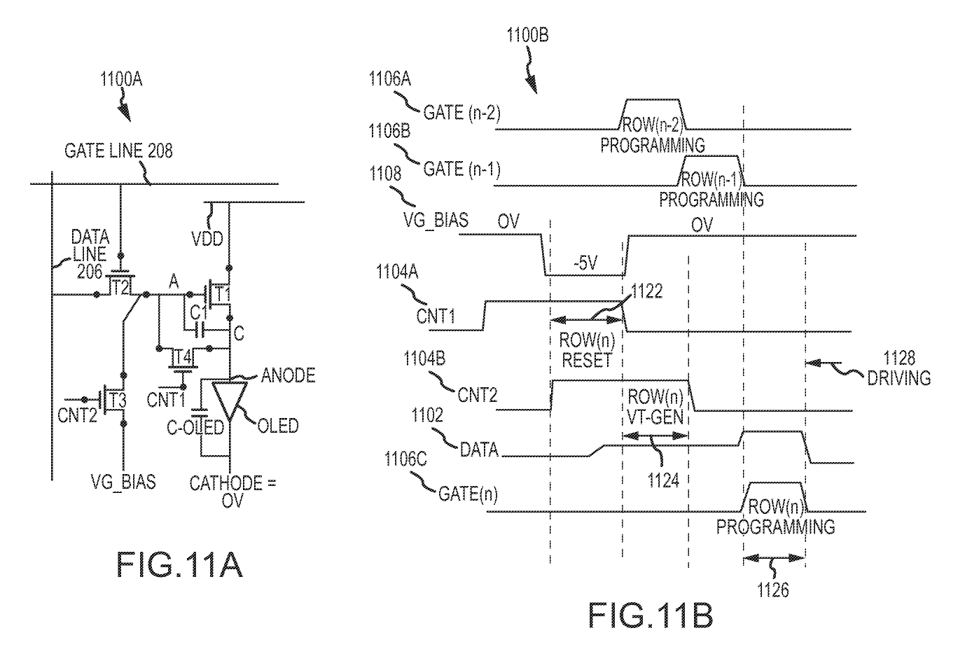

FIG. 11A illustrates a pixel circuit 1100A in a tenth embodiment of the present disclosure. Pixel circuit 1100A presents an alternative way to reset node C (OLED Anode) without toggling VDD. Pixel circuit 1100A includes two extra transistors T₃ and T₄ compared to conventional pixel circuit. Transistor T₄ is added between nodes A and C, and controlled by CNT₁. Transistor T₃ is connected to node A, applied by a bias line V_{G}_{_{—}}_{BIAS} and controlled by CNT₂.

FIG. 11B illustrates a driving scheme 1100B for the pixel circuit 1100A in the tenth embodiment of the present disclosure. When control voltage signal CTN₂ is set “HIGH” to control transistor T₃, reset phase 1122 starts. During the reset phase 1122, nodes A and C are shorted to a VG_BIAS voltage through transistors T₃ and T₄. (e.g. about 3 to 4 volts lower than negative of threshold voltage of driver transistor T₁). For example, if the threshold voltage of driver transistor T₁ is about 2 volts, then nodes A and C are pulled down to negative 5 volts (or any suitable voltage) during the reset phase. It is important to note that the driver transistor T₁ is “OFF” during the reset phase 1122, because the gate-to-source voltage V_{gs} is equal to zero. Therefore, no static current is drawn from the fixed VDD during the reset phase.

Subsequently, transistor T₄ is disabled, which is controlled by CNT₁ 1104A, and then the VT-generation phase 1124 starts. Node A is pulled to 0 volts, and node C charges to negative 2 volts, which is negative of the threshold voltage of driver transistor T₁. When voltage signal GATE (n) 1106C from gate line 208 is set “HIGH”, programming phase 1126 for row (n) starts. The reset and VT-generation phases 1122 and 1124 are independent of the programming phase 1126. It is also important to note that CNT₁ 1104A and CNT₂ 1104B are delayed waveforms such that CNT₁ 1104A of one row can be tapped from CNT₂ 1104B of a previous row. This means that only one control signal CNT₂ and one additional bias line V_{G}_{_{—}}_{BIAS} is routed through the pixels. The voltage numbers mentioned above are only an example, and the actual values depend on the design and the transistor characteristics.

In the tenth embodiment as shown in FIG. 1100A, during the programming phase, the voltage at node C increases as node A is programmed. This reduces the gate-to-source voltage V_{gs} of driver transistor T₁, and increases the required dynamic range on the data line. Although this increase in dynamic range can be addressed by increasing C_{oled}, the increase in C_{oled} is limited for high resolution small displays.

This pixel circuit 1100A enables faster refresh rate and fixed VDD design. This pixel circuit 1100A is also very suitable for small displays, which do not suffer from the RC delay induced non-uniformity. The tenth embodiment utilizes four transistors, and requires an additional bias line and one additional control line, and does not provide large area uniformity. This tenth embodiment has a simple gate driver design due to the fixed VDD.

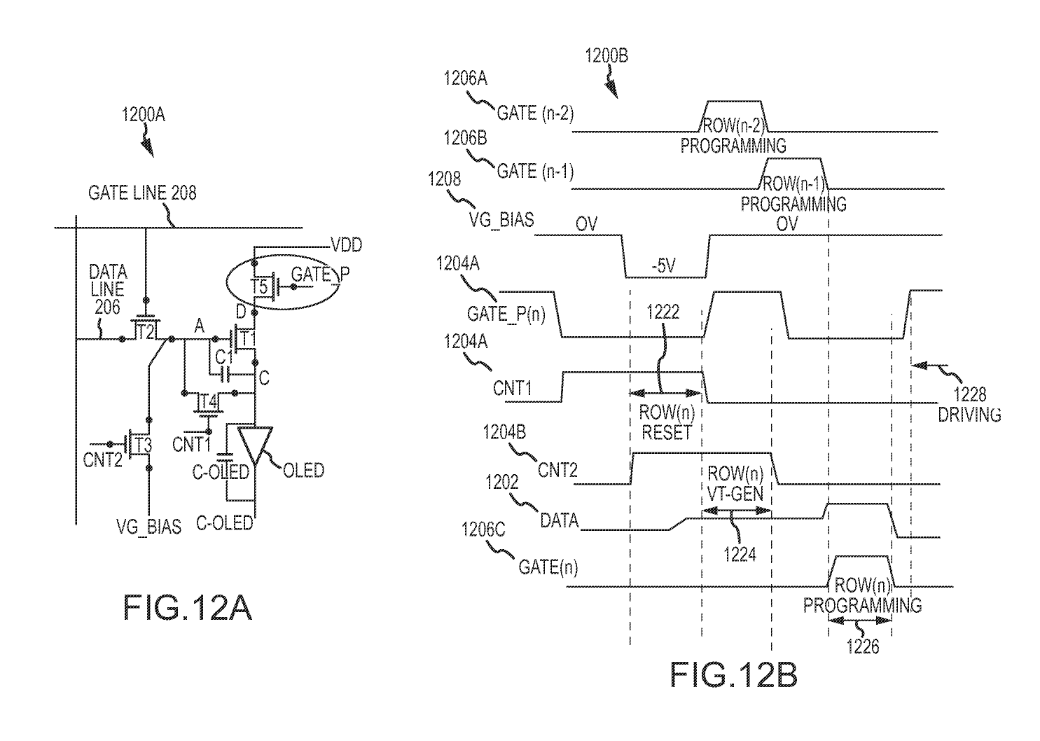

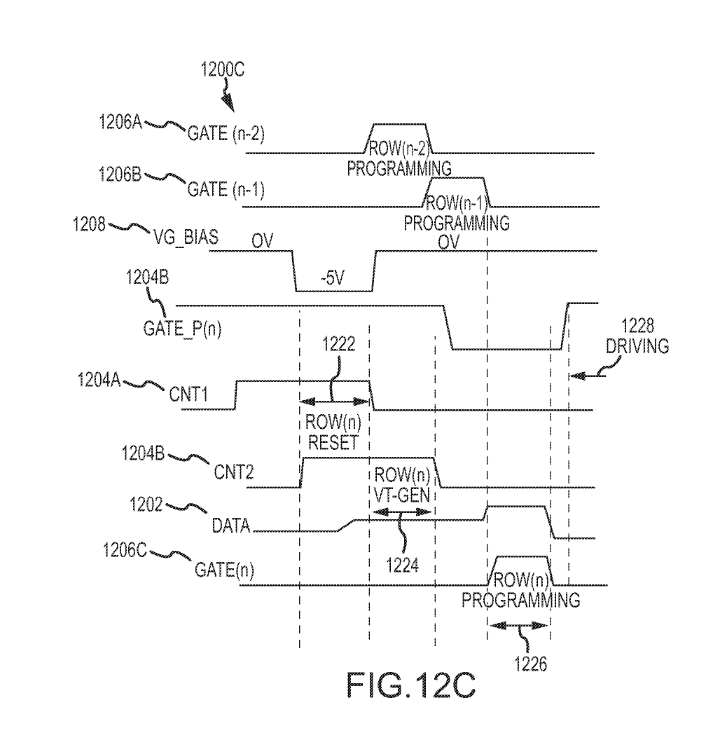

FIG. 12A illustrates a pixel circuit 1200A in an eleventh embodiment of the present disclosure. FIG. 12B illustrates a driving scheme 1200B for the pixel circuit 1200A in the eleventh embodiment of the present disclosure. FIG. 12C illustrates an alternative driving scheme 1200C for the pixel circuit 1200A in the eleventh embodiment of the present disclosure.

Pixel circuit 1200A is useful for small displays. Pixel circuit 1200A is modified from pixel circuit 1100A by adding an additional transistor T₅ controlled by an additional control signal GATE_P. Transistor T₅ is between drain of transistor T₁ at node D and VDD. In pixel circuit 1200A, transistor T₅ ensures that node C does not rise significantly during the programming phase. This makes the design of capacitors less complicated, helps reduce the size of T₄, and reduces the dynamic range of the data line. Also, node D is disconnected from VDD when GATE_P toggles low, before the onset of the programming phase. Because of clock feed through, node D couples with GATE_P and is pre-discharged to a much lower level than VDD. This reduces charge sharing between nodes C and D during the programming phase, and improves large area brightness uniformity. For GATE_P, waveform 1204A in driving scheme 1200B as shown in FIG. 12B or waveform 1204B in driving scheme 1200C as shown in FIG. 12C can be used. Note that DATA 1202 is similar to DATA 614 for driving scheme 600B for pixel circuit 600A. GATE(n) 1206C, GATE(n−1) 1206B and GATE(n−2) 1206A are similar to those for driving scheme 600B. Because of the parallel operation of different phases 1222, 1224, and 1226 for different rows, the row programming time 1226 becomes the row time for this pixel circuit 1200A. Row time 1226 is shorter than row time 402 for pixel circuit 400A.

This pixel circuit 1200A utilizes five transistors and two additional control lines, one additional bias signal. This embodiment provides faster refresh rate, fixed VDD, small dynamic range on the data line and large area uniformity. Also, CNT₁ 1204A can be tapped from the CNT₂ 1204B signal of a previous row. This pixel circuit may be suitable for both large area and small area high resolution AMOLEDs.

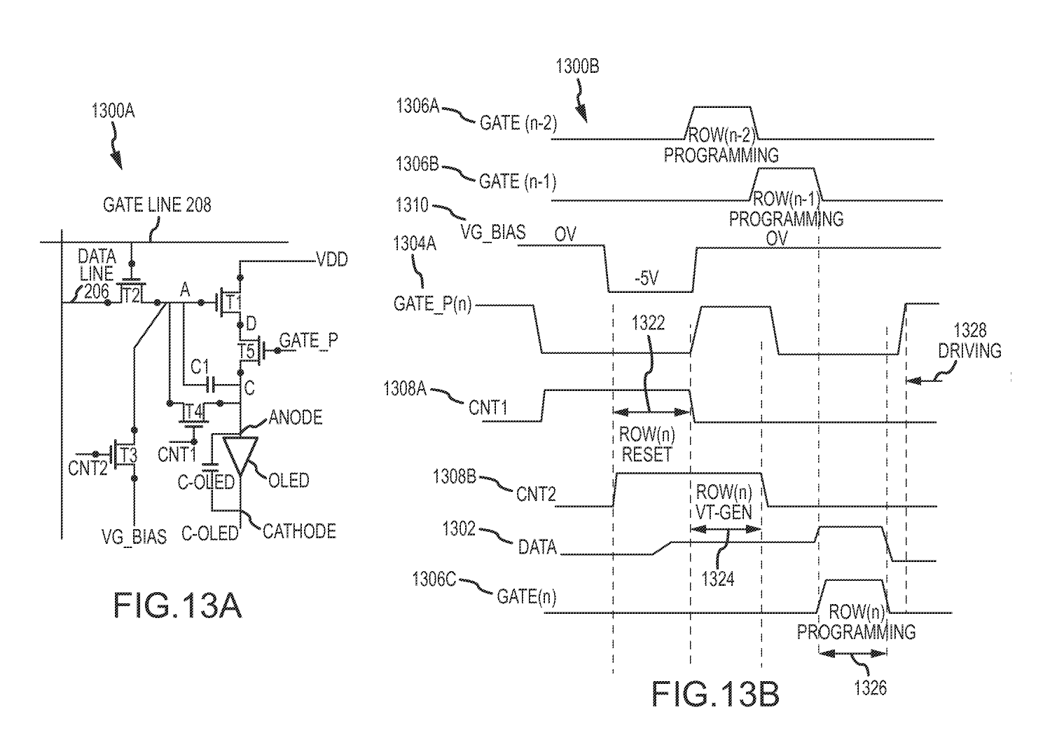

FIG. 13A illustrates a pixel circuit 1300A in a twelfth embodiment of the present disclosure. This embodiment is modified from the eleventh embodiment or pixel circuit 1200A. Pixel circuit 1300A is another version of pixel circuit 1200A. Transistor T₅ is arranged between anode 1706 of OLED at node C and source of transistor T₁ at node D.

FIG. 13B illustrates a driving scheme 1300B for the pixel circuit 1300A in the twelfth embodiment of the present disclosure. FIG. 13C illustrates an alternative driving scheme 1300C for the pixel circuit 1300A in the twelfth embodiment of the present disclosure. Waveform 1304A for GATE_P in driving scheme 1300B can be modified to be like waveform 1204B in driving scheme 1200C such that it is asserted low only during the programming phase. Note that DATA 1302 is similar to DATA 614 for driving scheme 600B for pixel circuit 600A. GATE(n) 1306C, GATE(n−1) 1306B and GATE(n−2) 1306A are similar to those for driving scheme 600B. Because of the parallel operation of different phases 1322, 1324, and 1326 for different rows, the row programming time 1326 becomes the row time for this pixel circuit 1300A. Row time 1326 is shorter than row time 402 for pixel circuit 400A. CNT₁ 1308A and CNT₂ 1308B are similar to CNT₁ 1204A and CNT₂ 1204B in FIG. 12B.

The eleventh and twelfth embodiments may use five transistors, provide better large area uniformity, high refresh rate, fixed VDD, and small dynamic range on the data line, but require an additional bias line and two additional control lines. The eleventh and twelfth embodiments also have a simple gate driver design because of fixed VDD.

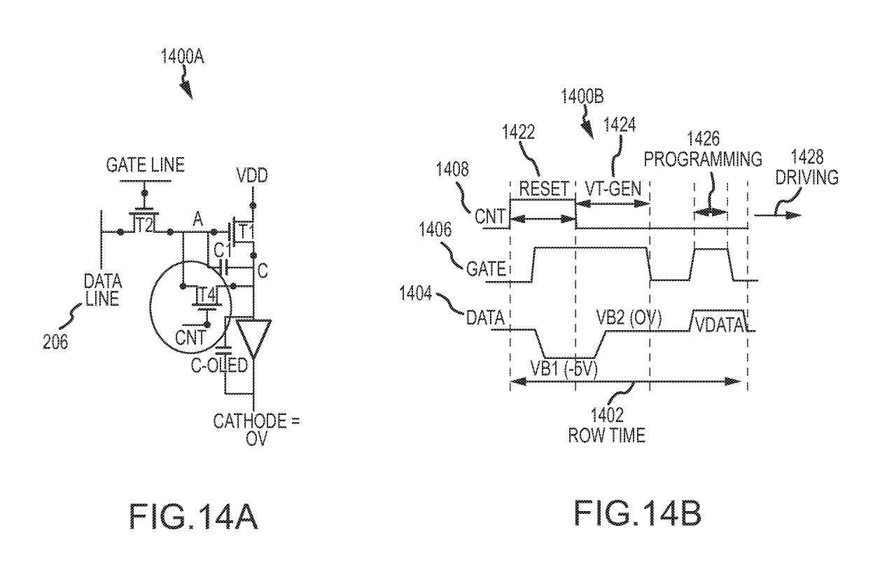

If faster refresh rate (e.g. 120 Hz) is not desired, then it is possible to eliminate one transistor in pixel circuits 1100A, 1200A, and 1300A to derive pixel circuits 1400A, 1500A and 1600A, respectively. FIG. 14A illustrates a pixel circuit 1400A in a thirteenth embodiment of the present disclosure. FIG. 14B illustrates a driving scheme 1400B for the pixel circuit 1400A in the thirteenth embodiment of the present disclosure. Four phases including reset phase 1422, VT-generation phase 1424, programming phase 1426 and driving phase 1428 are sequentially operated for each row. CNT 1408 is similar to CNT₁ 1104A, shown in FIG. 11B. DATA 1404 has three different values—a first value during the reset phase, a second value during the VT-generation phase and a third value during the programming phase. GATE 1406 is similar to GATE 406 as shown in FIG. 4B. Pixel circuit 1400A along with driving scheme 1400B provides fixed VDD, only three TFTs, usable for small displays, and regular refresh rate of 60 Hz.

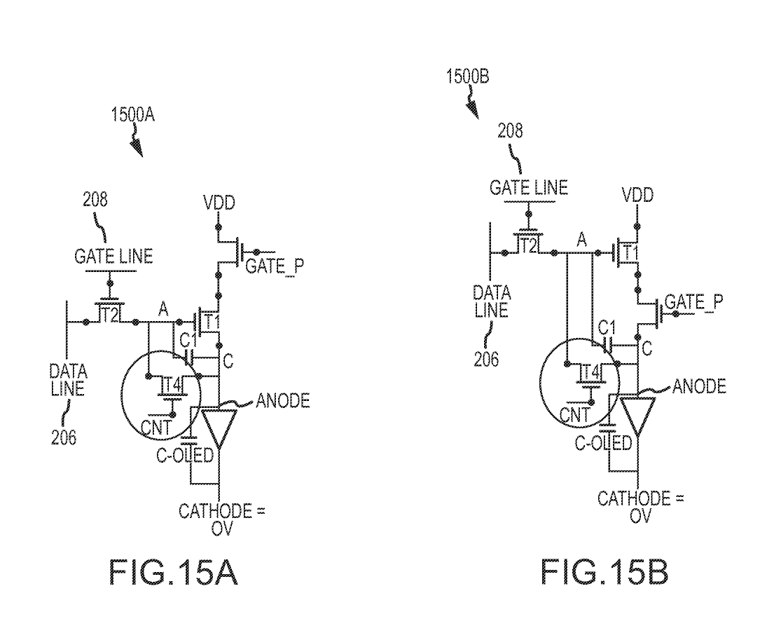

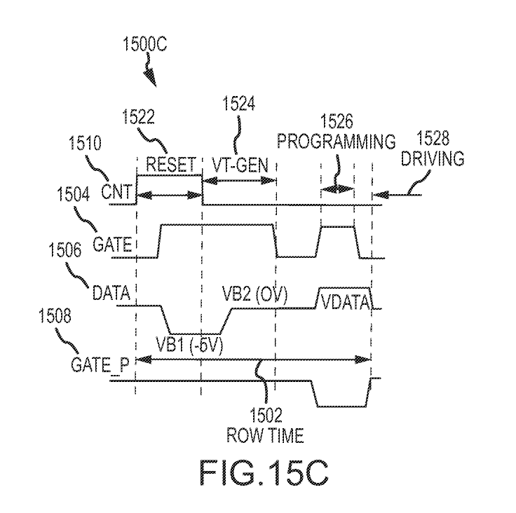

FIG. 15A illustrates a pixel circuit 1500A in a fourteenth embodiment of the present disclosure. FIG. 15B illustrates a pixel circuit 1500B in a fifteen embodiment of the present disclosure. FIG. 15C illustrates a driving scheme 1500C for the pixel circuits 1500A and 1500B in the fourteenth and fifteenth embodiment of the present disclosure. Pixel circuits 1500A and 1500B require two additional control lines and four transistors, and provide fixed VDD, large area uniformity, smaller dynamic range on data line for a regular refresh rate of 60 Hz. Note that using a fixed VDD can simplify the gate driver and flex design significantly, because VDD does not need to be derived per row. The fourteenth and fifteenth embodiments require no additional bias line, but do not provide high refresh rate. The fourteenth and fifteenth embodiments also have a relatively simple gate driver design.

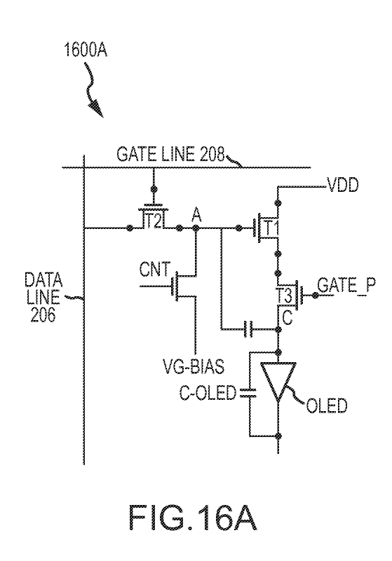

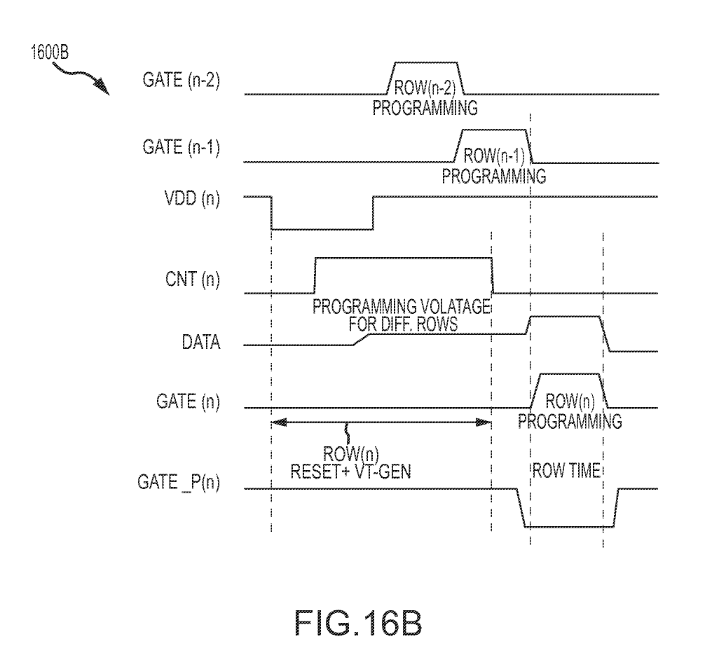

FIG. 16A illustrates a pixel circuit 1600A in a sixteenth embodiment of the present disclosure. This embodiment combines features of pixel circuits 400A and 600A. FIG. 16B illustrates a driving scheme 1600B for the pixel circuit 1600A in the sixteenth embodiment of the present disclosure.

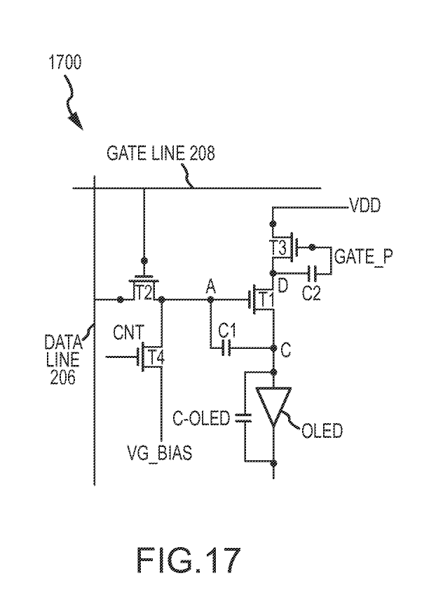

FIG. 17 illustrates a pixel circuit 1700 in a seventeenth embodiment of the present disclosure. This embodiment combines features of pixel circuits 500A and 600A. The driving scheme for pixel circuit 1700 is the same as driving scheme 1600B.

The sixteenth and seventeenth embodiments utilize four transistors, provide better large area uniformity, high refresh rate, small dynamic range on the data line, and requires no additional bias line, but toggles VDD, requires two additional control lines. VG_Bias can be shorted to the cathode. The sixteenth and seventeenth embodiments may have a complex gate driver design.

The transistors present in this disclosure are n-type transistors, which may be fabricated by using various processes including complementary metal-oxide-semiconductor (CMOS) process, low temperature poly-silicon (LTPS) and metal oxide semiconductors. It will be appreciated by those skilled in the art that variations in the pixel circuits may be made to use p-type transistors.

Having described several embodiments, it will be recognized by those skilled in the art that various modifications, alternative constructions, and equivalents may be used without departing from the spirit of the disclosure. Additionally, a number of well-known processes and elements have not been described in order to avoid unnecessarily obscuring the embodiments disclosed herein. Accordingly, the above description should not be taken as limiting the scope of the document.

Those skilled in the art will appreciate that the presently disclosed embodiments teach by way of example and not by limitation. Therefore, the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. A method of driving a pixel circuit for a display, the circuit including an organic light emitting diode (OLED), a storage capacitor, a first transistor for driving the OLED, a second transistor for switching the OLED, and a third transistor, the method comprising:
controlling the second transistor by a first signal from a gate line such that the second transistor is switched off for a first phase, on for a second phase and a third phase, and off for a fourth phase;
controlling the third transistor with a second signal at the gate of the third transistor;
during the second phase, storing a threshold voltage of the first transistor on the storage capacitor coupled between the gate and the source of the first transistor;
during the third phase, supplying a data voltage from a data line to the gate of the first transistor, and
switching off the third transistor with the second signal such that the voltage at an anode of the OLED does not vary with pixel location.

2. The method of claim 1, further comprising: during the fourth phase, driving the OLED by the voltage at the source of the first transistor.

3. The method of claim 1, wherein the anode of the OLED is configured to receive a current from the first transistor.

4. The method of claim 1, further comprising providing a third signal from a power supply to the drain of the first transistor, and toggling the third signal being between a first voltage and a second voltage.

5. The method of claim 1, further comprising providing a fixed voltage signal from a power supply to the drain of the first transistor.

6. The method of claim 1, further comprising: during the first phase, supplying a reference voltage to a first terminal of the storage capacitor at the gate of the first transistor to ensure that the OLED does not emit light and each pixel has the same voltage at the anode of the OLED.

7. The method of claim 6, wherein the reference voltage allows a current to conduct in the first transistor but not to allow the OLED to be turned on to emit light.

8. The method of claim 1, further comprising: during the second phase, supplying a data voltage to the gate of the first transistor, and developing a voltage across the capacitor to be substantially the same as the threshold voltage of the first transistor.

9. The method of claim 1, further comprising: during the third phase, storing a voltage on the capacitor for the OLED, the voltage being a sum of the threshold voltage and the data voltage, the data voltage representing the level of illumination.

10. The method of claim 1 wherein the second signal is provided from a control line.

11. A method of driving a pixel circuit for a display, the pixel circuit including an organic light emitting diode (OLED), a storage capacitor, a first transistor for driving the OLED, and a second transistor and a third transistor as a switch, the method comprising:
toggling to a first value of a power supply signal coupled to the drain of the first transistor to start a first phase;
during the first phase, providing a first value of data voltage from a data line to the gate of the first transistor;
toggling to a second value of the power supply signal to start a second phase;
during the second phase, providing a second value of the data voltage to the gate of the first transistor, the second value being higher than the first value;
starting a third phase by a control signal from a gate line, the control signal being coupled to the second transistor to turn “ON” and “OFF” of the second transistor;
during the third phase, supplying a third value of data voltage representing a level of illumination to the gate of the first transistor for driving the OLED, the second value being higher than the second value;
simultaneously providing the first value of a data voltage from a data line during the third phase for a nₜₕ row of pixels of the display and the second value of the data voltage during the second phase for a (n−1)th row of pixels of the display and the third value of the data voltage during the first phase for a (n−2)th row of pixels of the display; and
producing a voltage at the source of the first transistor coupled to an anode of the OLED.

12. The method of claim 11, further comprising: during the fourth phase, driving the OLED by the voltage at the source of the first transistor.

13. The method of claim 11, wherein the anode of the OLED is configured to receive a current from the first transistor.

14. The method of claim 11, wherein the voltage stored at the storage capacitor reaches the threshold voltage of the first transistor during the second phase.

15. The method of claim 11, wherein the voltage stored at the storage capacitor reaches a sum of the threshold voltage of the first transistor and the data voltage supplied from the data line during the third phase.

16. The method of claim 11, wherein the third transistor comprises a drain coupled to the gate of the first transistor that couples to the second transistor.

17. The method of claim 11, wherein the third transistor comprises a gate controlled by a signal from a control line.

18. The method of claim 11, wherein the third transistor comprises a source controlled by a signal from a bias line.

19. The method of claim 11, wherein the first value allows a current to conduct in the first transistor but not to allow the OLED to be turned on to emit light.
